(19) United States
(12) Patent Application Publication
(10) Pub. No.: US 2024/0010826 A1
(43) Pub. Date: Jan. 11, 2024

(54) VINYLIDENE FLUORIDE POLYMER COMPOSITION AND METHOD OF PRODUCING SAME, RESIN COMPOSITION, ELECTRODE MIXTURE, AND ELECTRODE CONTAINING THESE, AND METHOD OF PRODUCING SAME

(71) Applicant: Kureha Corporation, Tokyo (JP)

(72) Inventors: Takuya IKEDA, Tokyo (JP); Tamito IGARASHI, Tokyo (JP); Masataka KATONO, Tokyo (JP); Kayoko OKADA, Tokyo (JP); Yoshiyuki NAGASAWA, Tokyo (JP)

(73) Assignee: Kureha Corporation, Tokyo (JP)

(21) Appl. No.: 18/254,490

(22) PCT Filed: Nov. 25, 2021
(86) PCT No.: PCT/JP2021/043110

§ 371 Date: May 25, 2023

(30) Foreign Application Priority Data
Nov. 30, 2020 (JP) 2020-198127

(51) Int. Cl. C08L 27/16; C08K 5/42; H01M 4/62; H01M 4/139

(52) U.S. Cl. CPC C08L 27/16; C08K 5/42; H01M 4/623; H01M 4/139; C08L 2201/52

(57) ABSTRACT

An objective is to provide a vinylidene fluoride polymer composition that is difficult to swell and dissolve in N-methyl-2-pyrrolidone and can form an electrode with a smooth surface. The vinylidene fluoride polymer composition contains a vinylidene fluoride polymer with a melting point of 130° C. or higher. When the vinylidene fluoride polymer composition and N-methyl-2-pyrrolidone are mixed to prepare a vinylidene fluoride polymer dispersion with a content of the vinylidene fluoride polymer of 6 mass %, a ratio of a viscosity of the vinylidene fluoride polymer dispersion at 30° C. to a viscosity of N-methyl-2-pyrrolidone at 30° C. is 20 or less, and when the vinylidene fluoride polymer dispersion is stirred and then allowed to stand for 15 minutes, a rate of change in content of the vinylidene fluoride polymer in an upper 40 volume % area of the vinylidene fluoride polymer dispersion before and after the standing is 2 mass % or less.

### TECHNICAL FIELD

The present invention relates to a vinylidene fluoride polymer composition and a method of producing the same, a resin composition, an electrode mixture, and an electrode containing these and a method of producing the same.

### BACKGROUND ART

In electrodes of secondary batteries or the like, polyvinylidene fluoride (hereinafter also referred to as “PVDF”) is widely used as a binding agent for binding an active material to a current collector. Such electrodes are formed by applying an electrode mixture containing PVDF, an active material, and a solvent, such as N-methyl-2-pyrrolidone (hereinafter also referred to as “NMP”), onto a current collector and removing the solvent. Insufficient removal of the solvent tends to reduce battery performance. However, removing the solvent sufficiently is time-consuming, which has been a production cost issue.

To address the problem, cost reduction by reducing the amount of NMP to be mixed with PVDF or the like and productivity improvement by reducing drying time are considered. However, typical PVDF easily swells and dissolves in NMP. This tends to increase the viscosity of the electrode mixture, and because of the need to ensure the coatability of the electrode mixture, reducing the amount of NMP has been difficult.

To deal with this, Patent Documents 1 and 2 propose vinylidene fluoride polymers with reduced solubility in NMP. These documents describe that the crystallinity of the vinylidene fluoride polymer is increased to reduce the swelling and solubility in NMP and thus to reduce the amount of NMP used in the electrode mixture.

### CITATION LIST

### Patent Literature

Patent Document 1: JP 2020-041065 A
Patent Document 2: WO 2020/054274

### SUMMARY OF INVENTION

### Technical Problem

However, when a mixture layer is formed using a vinylidene fluoride polymer with low swelling and solubility in NMP, it has been found that the resulting electrode surface tends to have reduced smoothness. The present invention has been made in view of the problem. The objective is to provide a vinylidene fluoride polymer composition that does not readily swell and dissolve in N-methyl-2-pyrrolidone and further can form an electrode with a smooth surface; a resin composition; an electrode mixture; a method of producing the same; and the like.

### Solution to Problem

The present invention provides a vinylidene fluoride polymer composition containing a vinylidene fluoride polymer having a melting point of 130° C. or higher, wherein
when the vinylidene fluoride polymer composition and N-methyl-2-pyrrolidone are mixed to prepare a vinylidene fluoride polymer dispersion having a content of the vinylidene fluoride polymer of 6 mass %,
a ratio of a viscosity of the vinylidene fluoride polymer dispersion at 30° C. measured by a parallel plate rheometer at a shear rate of 100 s⁻¹ to a viscosity of N-methyl-2-pyrrolidone at 30° C. measured by a parallel plate rheometer at a shear rate of 100 s⁻¹ is 20 or less, and
when the vinylidene fluoride polymer dispersion is stirred and then allowed to stand undisturbed for 15 minutes, a rate of change in a content of the vinylidene fluoride polymer in an upper 40 volume % portion of the vinylidene fluoride polymer dispersion before and after the dispersion is allowed to stand undisturbed is 2 mass % or less.

The present invention also provides a resin composition containing:
the vinylidene fluoride polymer composition described above and
an additional resin,
wherein the additional resin is at least one polymer selected from the group consisting of vinylidene fluoride-based polymers other than the vinylidene fluoride polymer, polyacrylonitrile, nitrile rubber, poly((meth)acrylic acid) and esters of poly((meth)acrylic acid), poly(vinylpyrrolidone), poly(vinyl alcohol), poly(vinyl acetal), poly(vinyl butyral), and cellulose ether.

The present invention also provides a method of producing a vinylidene fluoride polymer composition, the method including:
obtaining a latex in which an untreated vinylidene fluoride polymer is dispersed in water; and
heating the latex at a temperature, the temperature being: lower than a melting point of the untreated vinylidene fluoride polymer; not lower than the melting point minus 20° C.; and not lower than 100° C., in a state where a surfactant is present in the latex, the surfactant having a non-perfluoro group as a hydrophobic group and an ionic group as a hydrophilic group.

The present invention also provides an electrode mixture containing:
the vinylidene fluoride polymer composition described above,
an active material, and
a dispersion medium. The present invention also provides an electrode mixture containing:
the resin composition described above,
an active material, and
a dispersion medium,
wherein the polymer in the resin composition is dissolved in the dispersion medium.

The present invention also provides an electrode including a mixture layer containing:
the vinylidene fluoride polymer composition described above or the resin composition described above and
an active material.

The present invention also provides a method of producing an electrode, the method including:
mixing the vinylidene fluoride polymer composition described above or the resin composition described above, an active material, and a dispersion medium to obtain an electrode mixture; and
applying the electrode mixture onto a current collector and drying the electrode mixture,
wherein a temperature of the electrode mixture is maintained at 60° C. or lower during a period from preparation to application of the electrode mixture.

### Advantageous Effects of Invention

The vinylidene fluoride polymer composition according to an embodiment of the present invention does not readily swell and dissolve in N-methyl-2-pyrrolidone and can reduce the amount of the dispersion medium (NMP) used in the electrode mixture. In addition, an electrode with a smooth surface can be formed with the vinylidene fluoride polymer composition.

### DESCRIPTION OF EMBODIMENTS

1. Vinylidene Fluoride Polymer Composition

A vinylidene fluoride polymer composition according to an embodiment of the present invention is a composition containing at least a vinylidene fluoride polymer having a melting point of 130° C. or higher. The composition is usually preferably in a solid state at 25° C. In the present specification, “the composition is in a solid state at 25° C.” means that a main constituent component of the composition is in a solid state at 25° C., and the composition may partially contain a component in a liquid state (e.g., such as a surfactant) to the extent that the objective and effects of the present invention are not impaired.

The vinylidene fluoride polymer composition is particularly useful, for example, as a binding agent for a mixture layer of an electrode of a secondary battery. However, applications of the vinylidene fluoride polymer composition are not limited to a binding agent.

As described above, in an electrode mixture containing a typical vinylidene fluoride polymer and NMP, the vinylidene fluoride polymer easily swells and dissolves in NMP, and this has made it difficult to produce an electrode mixture having a low viscosity with a small amount of NMP. To deal with this, a technique has been proposed for making a vinylidene fluoride polymer difficult to swell and dissolve in NMP. However, when an electrode mixture obtained using such a vinylidene fluoride polymer is applied to form a mixture layer, the resulting electrode surface tends to have reduced smoothness.

As a result of diligent studies, the present inventors found that the vinylidene fluoride polymer having low swelling and solubility in NMP described above in Patent Documents 1 and 2 easily undergoes sedimentation in NMP. The tendency for sedimentation in NMP means that particles of the dispersed vinylidene fluoride polymer are large. Here, it is surmised that, when the electrode mixture containing the vinylidene fluoride polymer particles is applied to a current collector, the active material undergoes sedimentation during the period until the electrode mixture is solidified, and correspondingly, the vinylidene fluoride polymer particles tend to float. Then, when the electrode mixture that has been applied onto the current collector is heated, the vinylidene fluoride polymer particles are usually swollen with NMP and then the particles undergo transition from the swollen state to a dissolved state. When the vinylidene fluoride polymer particles are in the dissolved state, the vinylidene fluoride polymer is presumed to be widely dispersed in the electrode mixture. However, the vinylidene fluoride polymer particles having a large particle size described above undergo a large volume change in the electrode mixture, the volume change due to swelling in NMP, during heating for solidifying the electrode mixture. Then, NMP volatilizes before the vinylidene fluoride polymer particles undergo transition from the swollen state to the dissolved state. Then, the electrode mixture solidifies before the vinylidene fluoride polymer floating in the vicinity of the electrode surface can spread to a wider area, and this tends to cause formation of voids having a size corresponding to the polymer particle size on the surface of the mixture layer. This has reduced the smoothness of the electrode surface.

In contrast, it has been found that a vinylidene fluoride polymer composition satisfying physical properties described below does not readily swell and dissolve in NMP that is used to form a mixture layer, and furthermore, when a mixture layer is formed using the vinylidene fluoride polymer composition, an electrode having highly smooth surface. Specifically, when the vinylidene fluoride polymer composition according to an embodiment of the present invention is mixed with NMP to prepare a vinylidene fluoride polymer dispersion having a vinylidene fluoride polymer content of 6 mass % at 25° C., a ratio (X/Y) is 20 or less, where X is a viscosity of the vinylidene fluoride polymer dispersion at 30° C. and Y is a viscosity of NMP at 30° C. When the viscosity ratio (X/Y) is 20 or less, the vinylidene fluoride polymer composition does not readily swell and dissolve in NMP at 30° C. That is, when an electrode mixture containing the vinylidene fluoride polymer composition and NMP is prepared, the viscosity of the electrode mixture is unlikely to increase at 30° C. Thus, an amount of NMP used in the electrode mixture can be reduced and the cost of NMP can be reduced and the productivity can be improved. The viscosity ratio (X/Y) is more preferably 10 or less and even more preferably 5 or less.

The viscosity Y of the NMP at 30° C. and the viscosity X of the vinylidene fluoride polymer dispersion at 30° C. are each measured using a parallel plate rheometer (parallel plate 50 mm, gap distance 0.5 mm) at a shear rate of 100 s⁻¹.

Here, the vinylidene fluoride polymer composition according to an embodiment of the present invention preferably does not dissolve in NMP at 30° C. but preferably easily swells and dissolves in NMP at temperatures exceeding 60° C. as described later. Thus, when the swellability and solubility of the vinylidene fluoride polymer composition at 30° C. are checked, that is, in the viscosity measurement, a temperature of the vinylidene fluoride polymer dispersion is preferably maintained at 60° C. or lower during a period from preparation of the vinylidene fluoride polymer dispersion to completion of the viscosity measurement. The temperature of the dispersion is more preferably maintained at 50° C. or lower and even more preferably maintained at 40° C. or lower.

In addition, for the vinylidene fluoride polymer composition according to an embodiment of the present invention, when the vinylidene fluoride polymer dispersion is stirred at 25° C. and then allowed to stand undisturbed for 15 minutes in a cylindrical container 1 cm in diameter, filled to a height of 5 cm, a rate of change in a content of the vinylidene fluoride polymer in an upper 40 volume % portion of the vinylidene fluoride polymer dispersion before and after the dispersion is allowed to stand undisturbed is 2 mass % or less. The change in the content before and after the dispersion is allowed to stand undisturbed indicates the tendency to sedimentation of the vinylidene fluoride polymer composition in NMP, and a smaller rate of change indicates the difficulty of sedimentation of the vinylidene fluoride polymer composition in NMP. In addition, the rate of change is 2 mass % or less for the vinylidene fluoride polymer composition according to an embodiment of the present invention. Thus, the vinylidene fluoride polymer composition does not readily undergo sedimentation in the electrode mixture containing the vinylidene fluoride polymer composition and NMP and to have a small particle size. Thus, when the electrode mixture containing the vinylidene fluoride polymer composition is applied and heated, the vinylidene fluoride polymer composition undergoes transition to a dissolved state without swelling excessively in NMP, and thus a volume change of the electrode is small during drying. This results in good surface smoothness of the resulting mixture layer and in turn, good surface smoothness of the electrode. The rate of change in the content is preferably 1.7 mass % or less and more preferably 1.5 mass % or less.

The change in the content of the vinylidene fluoride polymer dispersion is measured as follows. The vinylidene fluoride polymer dispersion is placed in a 50-mL vial and stirred with a magnetic stirrer for 10 minutes. In stirring, the vinylidene fluoride polymer dispersion is mixed and the temperature of the vinylidene fluoride polymer dispersion is always kept in the range of 20 to 30° C. When the vinylidene fluoride polymer dispersion is under stirring treatment, a portion of the vinylidene fluoride polymer dispersion is collected in a state while the stirring is continued, and the content of the vinylidene fluoride polymer in the dispersion is measured (content W1 of the vinylidene fluoride polymer before the vinylidene fluoride polymer dispersion is allowed to stand undisturbed). The polyvinylidene fluoride polymer dispersion is then placed in a cylindrical container 1 cm in diameter, and filled to a height of 5 cm, and is allowed to stand undisturbed at 25° C. for 15 minutes. The vinylidene fluoride polymer dispersion in an upper 40 volume % portion of the vinylidene fluoride polymer dispersion is collected using a pipette, and the content of the vinylidene fluoride polymer is measured (content W2 of the vinylidene fluoride polymer after the vinylidene fluoride polymer dispersion is allowed to stand undisturbed). The rate of change in the content is then calculated by the following equation:

$$( Rate of change ) = \frac{W 1 - W 2}{W 1} \times 100 [ mass \% ] \qquad [ Equation 1 ]$$

Examples of a method for measuring the content of the vinylidene fluoride polymer in the dispersion include a method including determining a content of the vinylidene fluoride polymer from a ratio of weights before and after drying when the collected dispersion is allowed to stand undisturbed and dried for 2 hours in a thermostatic vessel at 130° C. with nitrogen circulation.

Here, the vinylidene fluoride polymer composition according to an embodiment of the present invention may be composed only of the vinylidene fluoride polymer, but a specific surfactant may be present around the vinylidene fluoride polymer. With the vinylidene fluoride polymer composition containing a specific surfactant together with the vinylidene fluoride polymer, sedimentation can be easily prevented. Hereinafter, components in the vinylidene fluoride polymer composition, its preparation method, and the like will be described.

(1) Vinylidene Fluoride Polymer

The vinylidene fluoride polymer contained in the vinylidene fluoride polymer composition according to an embodiment of the present invention is a compound containing a structural unit derived from vinylidene fluoride and having a melting point of 130° C. or higher. The vinylidene fluoride polymer may be a homopolymer of vinylidene fluoride or may be a copolymer of vinylidene fluoride and another monomer. However, from the viewpoint of increasing the melting point of the vinylidene fluoride polymer to 130° C. or higher, an amount of the structural unit derived from vinylidene fluoride relative to a total amount of the structural units of the vinylidene fluoride polymer is preferably 90 mass % or greater, more preferably 95 mass % or greater, even more preferably 99 mass % or greater, and the vinylidene fluoride polymer is particularly preferably a homopolymer of vinylidene fluoride. A larger amount of the structural unit derived from vinylidene fluoride in the vinylidene fluoride polymer usually tends to result in a higher melting point, although this depends on a type of another monomer that is combined with vinylidene fluoride. A mass fraction of the structural unit derived from vinylidene fluoride can be identified by analysis of the vinylidene fluoride polymer by ¹⁹F-NMR.

Here, examples of another monomer copolymerizable with vinylidene fluoride include hydrocarbon-based monomers, such as fluorine-containing monomers other than vinylidene fluoride, ethylene, and propylene; unsaturated dibasic acid derivatives, such as alkyl (meth)acrylate compounds, monomethyl maleate, and dimethyl maleate; and carboxylic anhydride group-containing monomers. Examples that may be used include acryloyloxyethyl succinate, methacryloyloxyethyl succinate, acryloyloxypropyl succinate, methacryloyloxypropyl succinate, acryloyloxyethyl phthalate, methacryloyloxyethyl phthalate, and 2-carboxyethyl (meth)acrylate.

Examples of the fluorine-containing monomer include vinyl fluoride, trifluoroethylene, tetrafluoroethylene, chlorotrifluoroethylene, hexafluoropropylene, fluoroalkyl vinyl ether, and perfluoroalkyl vinyl ether represented by perfluoromethyl vinyl ether.

In addition, a melting point of the vinylidene fluoride polymer is 130° C. or higher but is more preferably 140° C. or higher and 175° C. or lower and even more preferably 150° C. or higher and 175° C. or lower. The melting point of the vinylidene fluoride polymer depends on the crystallinity of the vinylidene fluoride polymer, and the vinylidene fluoride polymer with higher crystallinity has a higher melting point.

The melting point of the vinylidene fluoride polymer can be determined by calorimetry using a differential scanning calorimeter (DSC). Specifically, the temperature of the vinylidene fluoride polymer is increased from 30° C. to 230° C. at 5° C./min (first temperature increase), reduced from 230° C. to 30° C. at 5° C./min (first cooling), further increased from 30° C. to 230° C. at 5° C./min (second temperature increase), and a melting peak is identified with a DSC. In addition, the maximum melting peak temperature Tm₁ observed in the first temperature increase is identified as the melting point of the vinylidene fluoride polymer.

Furthermore, for the vinylidene fluoride polymer, a peak area ΔH in a differential scanning calorimetry curve obtained in the first temperature increase in the calorimetry using a DSC is preferably 45.0 J/g or greater and more preferably 47.0 J/g or greater. When the vinylidene fluoride polymer has a ΔH in the range described above, the vinylidene fluoride polymer has an increased amount of the crystalline component and the vinylidene fluoride polymer composition becomes difficult to swell and dissolve in NMP at 25° C.

Here, the weight average molecular weight of the vinylidene fluoride polymer is preferably from 100000 to 10000000, more preferably from 200000 to 5000000, and even more preferably from 300000 to 2000000. The weight average molecular weight is a value measured by gel permeation chromatography (GPC) calibrated with polystyrene.

In the vinylidene fluoride polymer composition, the vinylidene fluoride polymer is preferably in the particulate form. When the vinylidene fluoride polymer composition is dispersed in a solvent, such as NMP, at 25° C., the vinylidene fluoride polymer in the dispersion is often in the form of primary particles. An average primary particle size of the particles of the vinylidene fluoride polymer determined for the dispersion by a dynamic light scattering method is preferably 5 μm or less, more preferably 3 μm or less, and even more preferably 1 μm or less. On the other hand, the average primary particle size is preferably 0.01 μm or greater, 0.05 μm or greater, and even more preferably 0.1 μm or greater. With the vinylidene fluoride polymer particles having an average primary particle size of 5 μm or less, sedimentation can be prevented when the vinylidene fluoride polymer particles are dispersed in NMP. And the electrode using the particles tends to have good surface smoothness.

The average primary particle size is calculated by regularization analysis of a dynamic light scattering method. For example, the average primary particle size is measured in accordance with JIS Z 8828 by DelsaMax CORE available from BECKMAN COULTER Inc. at a measurement temperature of 25° C. using water as a dispersion medium. In addition, the largest peak obtained by regularization analysis is defined as the average primary particle size.

Here, an amount of the vinylidene fluoride polymer in the vinylidene fluoride polymer composition is preferably 97 mass % or greater and 99.9 mass % or less, and more preferably 98 mass % or greater and 99.9 mass % or less. When the amount of the vinylidene fluoride polymer is in the range, and such a vinylidene fluoride polymer composition is used to form a mixture layer of an electrode, adhesiveness between the mixture layer and a current collector is good.

(2) Surfactant

As described above, the vinylidene fluoride polymer composition may further contain a specific surfactant. The surfactant may cover the entire periphery of the vinylidene fluoride polymer or may cover only a part of the vinylidene fluoride polymer. The surfactant may be identical to or different from the surfactant that is used for the polymerization of the vinylidene fluoride polymer.

Here, the surfactant contained in the vinylidene fluoride polymer composition is preferably a compound having a non-perfluoro group as a hydrophobic group and an ionic group as a hydrophilic group. Presence of such a surfactant around the vinylidene fluoride polymer makes the sedimentation difficult in mixing the vinylidene fluoride polymer composition with a solvent, such as NMP, and makes it easier to produce an electrode with a smooth surface.

Here, the hydrophobic group of the surfactant is a non-perfluoro group, and examples include an alkyl group, an alkylbenzene group, and a poly(oxyethylene) alkyl ether. Among these, a poly(oxyethylene) alkyl ether, a lauryl group, or the like is preferred from the viewpoint of affinity for the vinylidene fluoride polymer, ease of availability, and the like.

On the other hand, the hydrophilic group is not particularly limited as long as it is an ionic group, and examples include an anionic group, such as a carboxy group, a sulfo group, and a sulfate group; and a cationic group, such as a quaternary ammonium group and an alkylamine. Among these, a sulfate group is preferred from the viewpoint of stability of latex in the heating.

Specific examples of the surfactant in which the hydrophilic group is anionic include ammonium lauryl sulfate, sodium lauryl sulfate, poly(oxyethylene) lauryl ether acetate, sodium poly(oxyethylene) lauryl ether acetate, and alkylbenzene sulfonates.

Specific examples of the surfactant in which the hydrophilic group is cationic include stearylamine acetate and stearyltrimethylammonium chloride. The vinylidene fluoride polymer composition may contain only one or two or more of the surfactants. Among these, an anionic surfactant is more preferred.

An amount of the surfactant contained in the vinylidene fluoride polymer composition is preferably 0.001 mass % or greater and 3 mass % or less, and more preferably 0.01 mass % or greater and 2 mass % or less relative to a total amount of the vinylidene fluoride polymer and the surfactant. When the amount of the surfactant is 3 mass % or less, and the vinylidene fluoride polymer composition is used to form a mixture layer of an electrode, adhesiveness between the mixture layer and a current collector is good. The amount of the surfactant is measured by ¹H NMR.

(3) Physical Properties of Vinylidene Fluoride Polymer Composition

The vinylidene fluoride polymer composition according to an embodiment of the present invention satisfies the physical properties (the viscosity of the vinylidene fluoride polymer dispersion and the change in the content before and after the dispersion is allowed to stand undisturbed) described above, but the vinylidene fluoride polymer dispersion preferably further satisfies the following shear viscosity when the vinylidene fluoride polymer composition and NMP are mixed to prepare a vinylidene fluoride polymer dispersion with a vinylidene fluoride polymer content of 6 mass %. Specifically, when a shear viscosity at each temperature is measured by a parallel plate rheometer (parallel plate 50 mm, distance between gaps 0.5 mm) at a shear rate of 100 s⁻¹ while the vinylidene fluoride polymer dispersion is heated from 25° C. to 80° C. at a temperature increasing rate of 5° C./min, a temperature at which a shear viscosity reaches five times a shear viscosity at 30° C. is preferably 35° C. or higher and 60° C. or lower. The temperature at which the shear viscosity reaches five times the shear viscosity at 30° C. is more preferably 40° C. or higher and 60° C. or lower and even more preferably 45° C. or higher and 60° C. or lower. When the shear viscosity of the vinylidene fluoride polymer dispersion is in the range described above, the vinylidene fluoride polymer composition tends to be difficult to swell and dissolve in NMP at a low temperature (lower than 35° C.) and readily swells and dissolves in NMP when the temperature increases. Thus, when such a vinylidene fluoride polymer composition is used in an electrode mixture, the viscosity of the electrode mixture can be maintained at a low value during preparation of the electrode mixture (lower than 35° C.). Thus, the amount of NMP used can be reduced and the productivity is improved, as well as the vinylidene fluoride polymer composition swells and dissolves in a solvent during drying of the mixture, and desired adhesiveness can be provided.

The shear viscosity of the vinylidene fluoride polymer dispersion at 30° C. is preferably 3 mPa·s or greater and 100 mPa·s or less, and more preferably 3 mPa·s or greater and 20 mPa·s or less. When the vinylidene fluoride polymer dispersion having a shear viscosity at 30° C. is in the range described above, an increase in the viscosity of the electrode mixture containing the vinylidene fluoride polymer composition at low temperatures (lower than 35° C.) can be prevented and the amount of the dispersion medium (NMP) used can be reduced while the coatability of the electrode is maintained.

(4) Method of Producing Vinylidene Fluoride Polymer Composition

The vinylidene fluoride polymer composition satisfying the physical properties can be produced, for example, by the following method. However, the method of producing the vinylidene fluoride polymer composition is not limited to the following method.

The method of producing the vinylidene fluoride polymer composition includes:
obtaining a latex in which an untreated vinylidene fluoride polymer is dispersed in water (hereinafter also referred to as the “latex preparation”); and
heating the latex at a temperature, the temperature being: lower than a melting point of the untreated vinylidene fluoride polymer; and not lower than the melting point minus 20° C., in a state where a surfactant is present in the latex, the surfactant having a non-perfluoro group as a hydrophobic group, and an ionic group as a hydrophilic group (hereinafter also referred to as the “heating”). The method preferably further includes removing water from the latex after heating (hereinafter also referred to as the “drying”). In addition, after the latex preparation and before the heating, the method preferably includes adding a surfactant to the latex, the surfactant having a non-perfluoro group as a hydrophobic group, and an ionic group as a hydrophilic group (hereinafter also referred to as the “surfactant addition”). Furthermore, the method may further include a step besides these steps if necessary.

Latex Preparation

In the latex preparation, a latex in which an untreated vinylidene fluoride polymer is dispersed in water is prepared. In the present specification, the untreated vinylidene fluoride polymer refers to a vinylidene fluoride polymer prepared by a general method and refers to a vinylidene fluoride polymer that has not been subjected to a heat treatment that is not intended for drying after preparation of the vinylidene fluoride polymer and has not been subjected to treatment, such as mixing with an additional component. The untreated vinylidene fluoride polymer has substantially the same composition as the vinylidene fluoride polymer. However, heating the untreated vinylidene fluoride polymer in the heating described later or the like changes the crystalline state or the like. Thus, the untreated vinylidene fluoride polymer is different from the vinylidene fluoride polymer in physical properties or the like.

The untreated vinylidene fluoride polymer may be a homopolymer of vinylidene fluoride or may be a copolymer of vinylidene fluoride and another monomer. In addition, the melting point (hereinafter also referred to as “Tm”) of the untreated vinylidene fluoride polymer is preferably 130° C. or higher, more preferably 140° C. or higher and 175° C. or lower, and even more preferably 150° C. or higher and 175° C. or lower. The melting point of the untreated vinylidene fluoride polymer can be measured in the same manner as in the method for measuring the melting point of the vinylidene fluoride polymer.

In addition, the method of preparing a latex containing the untreated vinylidene fluoride and water may include dispersing a commercially available untreated vinylidene fluoride polymer in water by a known dispersion method. Furthermore, an untreated vinylidene fluoride polymer prepared by a method, such as suspension polymerization, emulsion polymerization, solution polymerization, or microsuspension polymerization, may be dispersed in water by a known dispersion method. The untreated vinylidene fluoride polymer may be pulverized by freeze pulverization, classification, or the like and then mixed with water.

On the other hand, vinylidene fluoride and, if necessary, another monomer is/are polymerized in water by an emulsion polymerization method, and this may be used as a latex. In the emulsion polymerization method, vinylidene fluoride, another monomer if necessary, water, and an emulsifier are mixed, and a water-soluble polymerization initiator is added to the mixed solution to polymerize vinylidene fluoride and another monomer. For the emulsifier and the polymerization initiator, known compounds can be used.

The emulsion polymerization method may be a method, such as soap-free emulsion polymerization or mini-emulsion polymerization. The soap-free emulsion polymerization method is a method of emulsion polymerization without using an ordinary emulsifier as described above. In addition, the mini-emulsion polymerization method is a method in which a strong shearing force is applied using an ultrasonic generator or the like to reduce the size of oil droplets of a monomer, such as vinylidene fluoride, to a submicron size, and the monomer is polymerized. In this case, a known hydrophobe is added to the mixed solution to stabilize the submicron-sized oil droplets of the monomer.

Here, in any of the emulsion polymerization methods described above, a chain transfer agent may be used to adjust a degree of polymerization of the untreated vinylidene fluoride polymer produced. Additionally, if needed, a pH adjusting agent may be used.

An additional optional component such as an anti-settling agent, a dispersion stabilizer, a corrosion inhibitor, an anti-fungal agent, and a wetting agent may be used, if needed. An amount of the additional optional component is preferably from 5 ppm to 10 parts by mass and more preferably from 10 ppm to 7 parts by mass per 100 parts by mass of the total amount of all monomers used in the polymerization.

Here, the content of the untreated vinylidene fluoride polymer in the latex is preferably 5 mass % or greater and 70 mass % or less, and more preferably 10 mass % or greater and 60 mass % or less. When the content of the untreated vinylidene fluoride polymer is 5 mass % or greater, the drying described later can be efficiently performed. On the other hand, when the content is 70 mass % or less, the latex is easily stabilized.

An average primary particle size of the untreated vinylidene fluoride polymer in the latex determined by a dynamic light scattering method is preferably 5 μm or less, more preferably 3 μm or less, and even more preferably 1 μm or less. On the other hand, the average primary particle size is preferably 0.01 μm or greater, 0.05 μm or greater, and even more preferably 0.1 μm or greater. The average primary particle size of the untreated vinylidene fluoride polymer in the latex can be determined in the same manner as the average primary particle size of the vinylidene fluoride polymer.

Surfactant Addition

The surfactant addition may be performed, in which a surfactant is added to the latex prepared in the latex preparation. The surfactant added is a compound having a non-perfluoro group as a hydrophobic group and an ionic group as a hydrophilic group. One type of the surfactant may be added, or two or more types of the surfactants may be added. The surfactant addition is not necessarily required when the latex prepared by an emulsion polymerization method contains a sufficient amount of the surfactant having a non-perfluoro group as a hydrophobic group and an ionic group as a hydrophilic group, and the surfactant is present in the latex before the heat treatment. The presence of the surfactant in the latex improves the stability in the subsequent heating and enables an appropriate treatment, and makes the resulting vinylidene fluoride polymer composition difficult to sediment when the composition is dispersed in NMP.

An amount of the surfactant added is preferably 0.001 parts by mass or greater and 3 parts by mass or less, and more preferably 0.01 parts by mass or greater and 2 parts by mass or less per 100 parts by mass of the total amount of the untreated vinylidene fluoride polymer in the latex. When the amount of the surfactant is excessively large, the adhesiveness between a mixture layer and a current collector may decrease when the vinylidene fluoride polymer composition obtained is used in a mixture layer. However, when the amount of the surfactant is 3 parts by mass or less, the effect on the adhesiveness is small. On the other hand, when the amount of the surfactant is 0.1 parts by mass or greater, the latex is easily stabilized during the heat treatment. An excess component of the surfactant added in this step may be removed by dialysis or the like after the heat treatment described later.

A temperature of the latex when the surfactant is added is preferably 15° C. or higher and 120° C. or lower, and more preferably 15° C. or higher and 100° C. or lower. Furthermore, the latex is preferably sufficiently stirred during and after the addition of the surfactant. The latex at a temperature of 15° C. or higher provides good workability. In addition, when the latex at a temperature of 120° C. or lower, the latex is easily stabilized and further does not require pressurizing the surfactant, advantageously.

Heating

In the heating, the latex is heated to a temperature in a state where the surfactant is present in the latex, the temperature being: lower than a melting point (Tm) of the untreated vinylidene fluoride polymer; Tm−20° C. or higher; and 100° C. or higher. The heating temperature is more preferably Tm−5° C. or lower and Tm−15° C. or higher, and even more preferably Tm−8° C. or lower and Tm−12° C. or higher.

Heating at the temperature described above crystallizes a part of the surface of the untreated vinylidene fluoride polymer and reduces the swelling and solubility in NMP. That is, the viscosity does not readily increase when the vinylidene fluoride polymer composition is dispersed in NMP as described above.

A heating time is preferably 10 seconds or more and 20 hours or less, more preferably 1 minute or more and 10 hours or less, and even more preferred 10 minutes or more and 5 hours or less. When the heat treatment time is in the range described above, the crystalline state of the untreated vinylidene fluoride polymer sufficiently changes easily, a vinylidene fluoride polymer satisfying the physical properties described above can be obtained.

The heating method is not particularly limited, and the latex may be heated without stirring or with stirring. A heating device is also not particularly limited. For example, the latex may be heated under pressure using an autoclave or the like.

In addition, after the heat treatment, the excess surfactant contained in the latex may be removed by dialysis, salting-out, acid precipitation, or the like. For example, dialysis can be performed by injecting the heat-treated latex into a dialysis membrane made of cellulose, immersing the latex together with the dialysis membrane in a water vessel filled with pure water, and exchanging the pure water in the water vessel at regular time intervals.

Drying

In the drying, water is removed from the heated latex. The method for removing water is not particularly limited, but the latex is preferably dried at a temperature that does not affect the physical properties of the vinylidene fluoride polymer composition in the latex. The drying may be performed under atmospheric pressure or under reduced pressure. The drying produces the vinylidene fluoride polymer composition. In addition, an apparatus for removing water is not particularly limited, and a shelf dryer, a conical dryer, a fluidized bed dryer, a flash dryer, a spray dryer, a freeze dryer, or the like can be used.

2. Resin Composition

The vinylidene fluoride polymer composition may be used as is in an electrode mixture for forming a mixture layer described later. On the other hand, a resin composition containing the vinylidene fluoride polymer composition and an additional resin that is dissolved during preparation of a mixture layer described later may be prepared and used in an electrode mixture for forming a mixture layer. Using the resin composition containing the vinylidene fluoride polymer composition and an additional resin in the electrode mixture makes adjustment of the viscosity of the electrode mixture to a desired range easier.

The additional resin is a resin that is different from the vinylidene fluoride polymer composition and is soluble in a solvent used in preparation of a mixture layer described later. Examples of the additional resin include vinylidene fluoride-based polymers other than the vinylidene fluoride polymer described above, polyacrylonitrile, nitrile rubber, poly((meth)acrylic acid) and esters of poly((meth)acrylic acid), poly(vinylpyrrolidone), poly(vinyl alcohol), poly(vinyl acetal), poly(vinyl butyral), and cellulose ether. The additional resin may contain only one type or two or more types of these.

The additional resin is preferably in particulate form, and a median size determined by a laser diffraction scattering method is preferably 0.1 μm or greater and 500 μm or less, and more preferably 0.5 μm or greater and 200 μm or less. The median size can be measured by a laser diffraction scattering method. For example, the median size can be measured by using a MICROTRAC MT3300EXII (measurement range from 0.02 to 2000 μm) available from MicrotracBEL Corp. and an automatic sample circulator, and using water as a dispersion medium. In addition, in the measurement, the additional resin particles may be wetted with ethanol and then dispersed in water.

Furthermore, an amount of the vinylidene fluoride polymer composition is preferably 5 parts by mass or greater and 2000 parts by mass or less, and more preferably 30 parts by mass or greater and 300 parts by mass or less per 100 parts by mass of the amount of the vinylidene fluoride polymer composition.

In addition, the method of mixing the vinylidene fluoride polymer composition with the additional resin is not particularly limited, and they may be mixed, for example, by dry mixing or wet mixing. Furthermore, after mixing the vinylidene fluoride polymer composition with the additional resin, the mixture may be processed into particles having a desired size with a roller compactor, a Pharmapaktor, a Chilsonator, a spray dryer, a fluidized bed granulator, and/or the like.

3. Electrode

The vinylidene fluoride polymer composition or resin composition can be used as a binding agent for a mixture layer of an electrode of a secondary battery or the like. The electrode includes, for example, a current collector and a mixture layer disposed on the current collector. In this case, the vinylidene fluoride polymer composition or resin composition can be used for forming the mixture layer. The electrode may be for a positive electrode or for a negative electrode.

(1) Current Collector

The current collectors for the negative and positive electrodes are terminals for collecting electricity. A material for each of the current collectors is not particularly limited, and metal foil, metal mesh, or the like of aluminum, copper, iron, stainless steel, steel, nickel, titanium, or the like can be used. In addition, the current collector may be one produced by applying the metal foil, metal mesh, or the like on a surface of a medium.

(2) Electrode Mixture and Mixture Layer

The mixture layer can be a layer produced by mixing the vinylidene fluoride polymer composition or resin composition, an active material, and a solvent to prepare an electrode mixture, applying the electrode mixture onto the current collector, and drying the mixture. The mixture layer may be produced only on one surface of the current collector or may be disposed on both surfaces.

The mixture layer contains, for example, the vinylidene fluoride polymer composition (or a resin composition containing the vinylidene fluoride polymer composition) and an active material and may contain an additional component if necessary. Examples of the additional component include a conductive additive and various additives.

A content of the vinylidene fluoride polymer composition relative to the total amount of the mixture layer is preferably 0.2 mass % or greater and 20 mass % or less, more preferably 0.4 mass % or greater and 10 mass % or less, and even more preferably 0.6 mass % or greater and 4 mass % or less. When the content of the vinylidene fluoride polymer composition is in the range described above, good adhesiveness between the mixture layer and the current collector can be achieved, for example.

The active material in the mixture layer is not particularly limited, and for example, a known active material for the negative electrode (negative electrode active material) or active material for the positive electrode (positive electrode active material) can be used.

Examples of the negative electrode active material include a carbon material, such as artificial graphite, natural graphite, non-graphitizable carbon, graphitizable carbon, activated carbon, and a material obtained by carbonizing a phenolic resin, a pitch, or the like by heat treatment; metal and metal alloy materials, such as Cu, Li, Mg, B, Al, Ga, In, Si, Ge, Sn, Pb, Sb, Bi, Cd, Ag, Zn, Hf, Zr, and Y; and metal oxides, such as GeO, GeO₂, SnO, SnO₂, PbO, and PbO₂.

On the other hand, examples of the positive electrode active material include a lithium-based positive electrode active material containing lithium. Examples of the lithium-based positive electrode active material include: complex metal chalcogenide compounds represented by the general formula LiMY₂ (where M is at least one type of transition metal or two or more types of transition metals such as Co, Ni, Fe, Mn, Cr, or V, and Y is a chalcogen element such as O or S) such as LiCoO₂ or LiNiₓCo₁₋ₓO₂ (0<x≤1); complex metal oxides having a spinel structure such as LiMn₂O₄; and olivine-type lithium compounds such as LiFePO₄.

A content of the active material relative to the total amount of the mixture layer is preferably 90 mass % or greater and 99.9 mass % or less, more preferably 92 mass % or greater and 99 mass % or less, and even more preferably 94 mass % or greater and 99 mass % or less. When the content of the active material is in the range described above, a sufficient charge/discharge capacity can be obtained and good battery performance can be readily obtained, for example.

In addition, the conductive additive is not particularly limited as long as it is a compound that can increase electrical conductivity between the electrode active material or between the active material and the current collector. Examples of the conductive additive include acetylene black, Ketjen Black, carbon black, graphite powder, carbon nanofibers, carbon nanotubes, and carbon fibers.

An amount of the conductive additive can be set according to the type of the conductive additive and the type of the battery. From the viewpoints of improving the conductivity and increasing the dispersibility of the conductive additive, in one example, the amount of the conductive additive is preferably 0.1 mass % or greater and 15 mass % or less, more preferably 0.1 mass % or greater and 7 mass % or less, and even more preferably 0.1 mass % or greater and 5 mass % or less relative to the total amount of the active material, the vinylidene fluoride polymer composition, and the conductive additive.

Examples of the additive include a phosphorus compound; a sulfur compound; an organic acid; a nitrogen compound, such as an amine compound and an ammonium compound; an organic ester; and various types of silane-based, titanium-based, and aluminum-based coupling agents. These are used in an amount to the extent that the objective and effects of the present invention are not impaired.

Here, a thickness of the mixture layer is not particularly limited and can be any thickness. Usually, the thickness of the mixture layer per side is preferably from 30 to 600 μm, more preferably from 50 to 500 μm, and even more preferably from 70 to 350 μm. In addition, an areal weight of the electrode mixture layer is usually preferably from 50 to 1000 g/m² and more preferably from 100 to 500 g/m².

Method of Forming Mixture Layer

The mixture layer can be produced by: preparing an electrode mixture by mixing the vinylidene fluoride polymer composition or resin composition, an active material, a solvent (dispersion medium), and an optional conductive additive and/or an optional additive of various types; applying the electrode mixture onto the current collector; and drying the electrode mixture.

The electrode mixture may be prepared by mixing the vinylidene fluoride polymer composition or resin composition, an active material, a solvent (dispersion medium), and an optional conductive additive and/or an optional additive of various types at once, or may be prepared by mixing some of the components first and then mixing the remaining components. At this time, the components are mixed preferably with a mixer equipped with a temperature controller to prevent an excessive increase of the temperature of the composition for the mixture layer.

In addition, the solvent (dispersion medium) can be any solvent in which the vinylidene fluoride polymer composition or the vinylidene fluoride polymer composition in the resin composition and the active material can be dispersed and the vinylidene fluoride polymer composition can be dissolved when the vinylidene fluoride polymer composition or the vinylidene fluoride polymer composition in the resin composition is heated to a temperature lower than the melting point. The solvent is usually preferably an aprotic polar solvent, such as NMP, and preferably NMP. An amount of the solvent is preferably 20 parts by mass or greater and 150 parts by mass or less, more preferably 20 parts by mass or greater and 100 parts by mass or less, even more preferably 20 parts by mass or greater and 45 parts by mass or less, and particularly preferably 20 parts by mass or greater and 35 parts by mass or less per 100 parts by mass of the amount of the active material. The vinylidene fluoride polymer composition has low swelling and solubility in NMP. Thus, even with the amount of the solvent of 150 parts by mass or less, a viscosity of the electrode mixture can be maintained within a desired range. When the electrode mixture including the resin composition is used, the polymer other than the vinylidene fluoride polymer composition in the electrode mixture dissolves in the solvent and functions as a dispersion stabilizer.

The viscosity of the electrode mixture is preferably 0.5 Pa·s or higher and 50 Pa·s or lower, and more preferably 2 Pa·s or higher and 30 Pa·s or lower. The viscosity of the electrode mixture is measured by an E-type viscometer or the like. When the electrode mixture has a viscosity of 0.5 Pa·s or higher, dripping during application of the electrode mixture to obtain the electrode, coating non-uniformity of the electrode, and delay in drying after the application can be prevented. Thus, such an electrode mixture can provide good workability in the electrode preparation. In addition, the electrode mixture having a viscosity of 50 Pa·s or lower provides good coatability of the electrode.

The method of applying the electrode mixture is not particularly limited, and a doctor blade method, a reverse roll method, a comma bar method, a gravure method, an air knife method, a die coating method, a dip coating method, and the like can be employed.

Here, a temperature of the electrode mixture is preferably maintained at 60° C. or lower during a period from the preparation to the application of the electrode mixture. The temperature of the electrode mixture is more preferably maintained at 0° C. or higher and 50° C. or lower and even more preferably maintained at 5° C. or higher and 40° C. or lower. As described above, the vinylidene fluoride polymer composition is difficult to swell and dissolve in a solvent (dispersion medium), such as NMP, at 25° C. But the composition easily dissolves in the solvent when the temperature increases. Thus, the viscosity of the electrode mixture can be maintained in a desired range by maintaining the temperature of the electrode mixture at 60° C. or lower during the period from the preparation to the application of the electrode mixture.

After the application of the electrode mixture, the electrode mixture is heated at any temperature to dry the solvent (dispersion medium). The drying may be performed multiple times at various temperatures. During the drying, pressure may be applied. The heating temperature is preferably 60° C. or higher and 200° C. or lower, and more preferably 80° C. or higher and 150° C. or lower. With the heating temperature in the range described above, the vinylidene fluoride polymer composition in the electrode mixture dissolves in the solvent (dispersion medium), increasing the fluidity. Thus, an electrode having a desired adhesiveness can be obtained. The heating time is preferably 30 seconds or more and 200 minutes or less, and more preferably 60 seconds or more and 150 minutes or less.

After the application and drying of the electrode mixture, press treatment may be further performed. Performing the press treatment can improve the electrode density.

### EXAMPLES

The present invention will be described in further detail below with reference to examples. The scope of the present invention is not to be construed as being limited by these examples.

1. Preparation of Vinylidene Fluoride Polymer Composition

Examples 1, 3, 5, 7, and 9, and Comparative Examples 2 and 4 The latex preparation, surfactant addition, heat treatment, and drying described below were performed, and vinylidene fluoride polymer compositions were obtained. The type and amount of the surfactant added in the surfactant addition and the temperature of the heat treatment in each example or comparative example are shown in Table 1.

Examples 2, 4, 6, 8, and 10, and Comparative Examples 3 and 5 The latex preparation, surfactant addition, heat treatment, dialysis, and drying described below were performed, and vinylidene fluoride polymer compositions were obtained. The type and amount of the surfactant added in the surfactant addition and the temperature of the heat treatment in each example or comparative example are shown in Table 1.

### Comparative Example 1

After the latex preparation described below, the drying was performed without performing the surfactant addition and the heat treatment, and a vinylidene fluoride polymer composition was obtained.

### Comparative Examples 6 to 8

After the latex preparation described below, the drying was performed without performing the surfactant addition and the heat treatment. A powder heat treatment was then further performed, and vinylidene fluoride polymer compositions were obtained. The temperature of the powder heat treatment of each comparative example is shown in Table 1.

### Comparative Example 9

After the latex preparation and the surfactant addition, the drying was performed without performing the heat treatment, and a vinylidene fluoride polymer composition was obtained. The type and amount of the surfactant added in the surfactant addition are shown in Table 1.

### Comparative Example 10

After the latex preparation described below, the heat treatment and the drying were performed without performing the surfactant addition, and a vinylidene fluoride polymer composition was obtained. The temperature of the heat treatment is shown in Table 1.

Latex Preparation

In an autoclave, 330 parts by mass of ion-exchanged water was placed and degassed by nitrogen bubbling for 30 minutes. Next, 0.1 parts by mass of disodium hydrogen phosphate and 0.8 parts by mass of perfluorooctanoate ammonium salt (PFOA) were added. The autoclave was pressured to 4.5 MPa and purged with nitrogen three times. Then, 0.05 parts by mass of ethyl acetate and 30 parts by mass of vinylidene fluoride (VDF) were added. The temperature was increased to 80° C. while the mixture was stirred. Then, 5 mass % of ammonium persulfate (APS) aqueous solution was added to give an APS amount of 0.05 parts by mass, and polymerization was started. The in-can pressure at this time was set to 2.5 MPa. From immediately after starting the polymerization, 70 parts by mass of VDF were continuously added to maintain the in-can pressure at 2.5 MPa of the start of the polymerization. After completion of the addition, the polymerization was completed when the pressure decreased to 1.5 MPa, and a latex containing vinylidene fluoride polymer A was obtained. The solid content of the resulting latex (content of vinylidene fluoride polymer A) was 21.5 mass %. The solid content was calculated by measuring the weight before and after drying the latex when about 5 g of the latex was placed to an aluminum cup and dried at 80° C. for 3 hours.

Surfactant Addition

In an autoclave was placed 800 g of the latex of the vinylidene fluoride polymer A at 25° C. The surfactant listed in Table 1 was each weighed in the amount as listed in Table 1 (amount relative to the vinylidene fluoride polymer) and placed into the autoclave. The weighed left on the wall surface of the vessel was washed into the autoclave using 70 g of pure water. For the types of surfactants in Table 1, ALS (ammonium lauryl sulfate) represents LATEMUL (trade name) AD-25 available from Kao Corporation, SLS (sodium lauryl sulfate) represents EMAL (trade name) 0 available from Kao Corporation, and POELEA (poly(oxyethylene) lauryl ether acetate) represents AKYPO (trade name) RLM45 available from Kao Corporation.

Heat Treatment

The latex containing the surfactant was placed in an autoclave, sealed, and heated to the temperature listed in Table 1 using a jacket temperature controller under stirring at 500 rpm. The treatment temperature was then maintained for 1 hour. After completion of the treatment, the jacket temperature controller was removed, and the temperature was lowered to 30° C. by air cooling in a sealed state. The autoclave was opened when the temperature dropped below 30° C., and the heat-treated latex was recovered.

Dialysis

The heat-treated latex was injected into a dialysis membrane made of cellulose (model number 521737, available from Sekisui Medical Co., Ltd., molecular weight cut-off from 12000 to 14000) and immersed together with the dialysis membrane in a water vessel filled with pure water. The pure water in the water vessel was replaced at regular time intervals (from 1 to 6 hours) and the latex was allowed to stand undisturbed for 2 days. The latex in the water vessel was then recovered from the dialysis membrane.

Drying

About 70 mL of the resulting latex (after the latex preparation, after the surfactant addition, after the heat treatment, or after the dialysis treatment) was placed in a 300-mL eggplant-shaped flask, and the content liquid was frozen using liquid nitrogen. Subsequently, the frozen eggplant-shaped flask was attached to a freeze dryer (FDU-2110 available from Tokyo Rikakikai Co., Ltd.). The inside pressure was reduced, and the eggplant-shaped flask was allowed to stand for about 8 hours. The eggplant flask was taken out from the freeze dryer, and the powder was recovered.

Powder Heat Treatment

After the latex preparation, about 8 g of the PVDF powder that had undergone the drying only was thinly spread in a vat made of SUS (30 cm×21 cm×2 cm). The vat was then covered with aluminum foil, placed in a hot air circulating oven (thermostatic vessel HT210 equipped with an explosion vent available from ETAC) set at a treatment temperature, and allowed to stand undisturbed for 1 hour with nitrogen circulation. The temperature-maintaining function was then stopped, and the temperature was lowered to 100° C. Then, the vat was taken out from the hot air circulating oven, the temperature was lowered to room temperature, and the powder was recovered.

2. Evaluation of Vinylidene Fluoride Polymer Composition

The vinylidene fluoride polymer compositions prepared as described above were evaluated as follows.

(1) Rate of Change in Content of Vinylidene Fluoride Polymer Dispersion

A vinylidene fluoride polymer dispersion with a vinylidene fluoride polymer content of 6 mass % was prepared by mixing 0.9 g of the vinylidene fluoride polymer composition obtained in each Example or each Comparative Example and 14.1 g of N-methyl-2-pyrrolidone (NMP). At this time, the mixing was performed so that the temperature of the vinylidene fluoride polymer dispersion was always in the range of 20 to 30° C.

The vinylidene fluoride polymer dispersion was then stirred using a magnetic stirrer at 25° C. for 10 minutes. When the vinylidene fluoride polymer dispersion was under stirring treatment, a portion of the vinylidene fluoride polymer dispersion was collected in a state while the stirring was continued, and the content of the vinylidene fluoride polymer in the dispersion was measured (content W1 of the vinylidene fluoride polymer before the vinylidene fluoride polymer dispersion was allowed to stand undisturbed). The polyvinylidene fluoride polymer dispersion was then placed in a height of 5 cm in a cylindrical container 1 cm in diameter at 25° C. and was allowed to stand undisturbed for 15 minutes. The vinylidene fluoride polymer dispersion in an upper 40 volume % portion of the vinylidene fluoride polymer dispersion was collected using a pipette, and the content of the vinylidene fluoride polymer was measured (content W2 of the vinylidene fluoride polymer after the vinylidene fluoride polymer dispersion had been allowed to stand undisturbed). The rate of change in the content was calculated by the equation below. The content of the vinylidene fluoride polymer in the dispersion was calculated from the ratio of weights before and after drying when the collected dispersion was allowed to stand undisturbed and dried for 2 hours in a thermostatic vessel at 130° C. with nitrogen circulation. The results are shown in Table 2.

[Equation 2]

$$Rate of change = \frac{W 1 - W 2}{W 1} \times 100 [ mass \% ]$$

(2) Ratio (X/Y) of Viscosity of Vinylidene Fluoride Polymer Dispersion to Viscosity of NMP

A vinylidene fluoride polymer dispersion having a vinylidene fluoride polymer content of 6 mass % was prepared in the same manner as in the measurement of the rate of change in the content. Then, the viscosity Y of NMP at 30° C. and the viscosity X of the vinylidene fluoride polymer dispersion at 30° C. were measured for 30 seconds using a G2 Rheometer (parallel plate 50 mm, gap distance 0.5 mm) available from TA Instruments, at a shear rate of 100 s⁻¹. Then, the value of X/Y was determined. The results are shown in Table 2. In addition, the viscosity X of the vinylidene fluoride polymer dispersion at 30° C. is also shown in Table 2.

(3) Temperature at which Shear Viscosity Reaches Five Times the Shear Viscosity at 30° C. (Thickening Temperature)

A vinylidene fluoride polymer dispersion having a vinylidene fluoride polymer content of 6 mass % was prepared in the same manner as in the measurement of the rate of change in the content. Then, the viscosity at each temperature was measured using a G2 Rheometer (parallel plate 50 mm, gap distance 0.5 mm) available from TA Instruments at a shear rate of 100 s⁻¹ while the temperature of the vinylidene fluoride polymer dispersion was increased from 25° C. to 80° C. at a rate of 5° C. per minute. Then, the viscosity at each temperature was divided by the viscosity at 30° C., and the temperature at which the shear viscosity reached 5 times the shear viscosity at 30° C. was determined. The results are shown in Table 2.

(4) Differential Scanning Calorimetry Measurement (DSC Measurement)

The vinylidene fluoride polymer composition was measured by differential scanning calorimetry using a DSC1 available from Mettler-Toledo International Inc. in accordance with JIS K 7122-1987. Specifically, about 10 mg of the sample was precisely weighed in an aluminum pan, nitrogen was fed at a flow rate of 50 mL/min, and the sample was measured under the following conditions.
First temperature increase: the temperature was increased from 30° C. to 230° C. at a rate of 5° C. per minute
First cooling: the temperature was lowered from 230° C. to 30° C. at a rate of 5° C. per minute
Second temperature increase: the temperature was increased from 30° C. to 230° C. at a rate of 5° C. per minute
The maximum melting peak temperature in the first temperature increase was indicated by Tm₁, and the maximum melting peak temperature in the second temperature increase was indicated by Tm₂. In addition, the peak area in the differential scanning calorimetry curve obtained in the first heating was taken as ΔH. The results are shown in Table 3.

(5) Measurement of Residual Surfactant Amount

The residual surfactant amount in the vinylidene fluoride polymer composition was measured by the following method (¹H NMR measurement). The results are shown in Table 3. (¹H NMR measurement)
Instrument
AVANCE AC 400FT NMR spectrometer, available from Bruker Corp.
Measurement conditions
Frequency: 400 MHz
Measurement solvent: DMSO-d6
Measurement temperature: 25° C.

Based on the integrated intensities of the signal observed at 0.85 ppm originating mainly from the alkyl chain end of the surfactant and the signals observed at 2.24 ppm and 2.87 ppm originating mainly from vinylidene fluoride in ¹H NMR spectrum, an amount of each component present was calculated and the ratio of the residual surfactant amount to the total vinylidene fluoride polymer composition amount was calculated.

3. Formation of Electrode

(1) Preparation of Polymer B

An autoclave having an internal volume of 2 liters was charged with 925 g of ion-exchanged water, 0.65 g of Metolose (trade name) SM-100 (available from Shin-Etsu Chemical Co., Ltd.), 4.0 g of a 50 wt. % diisopropyl peroxydicarbonate-HCFC 225cb solution, 421 g of vinylidene fluoride, and 0.22 g of acryloyloxypropyl succinate, and the temperature was increased to 26° C. over 1 hour. The temperature was then maintained at 26° C., and a 3 wt. % acryloyloxypropyl succinate aqueous solution was gradually added at a rate of 0.19 g per minute. A total of 2.92 g of acryloyloxypropyl succinate was added, including the initially added amount. The polymerization was terminated at the same time as the completion of the addition of the acryloyloxypropyl succinate aqueous solution. The resulting polymer slurry was dehydrated, washed with water, and further dried at 80° C. for 20 hours, and Polymer B was obtained. The weight average molecular weight was 800000, the median diameter (D50) was 180 μm, and the melting point was 169.3° C.

(2) Preparation of Binder Composition

Into a conical flask was weighed 85 parts by mass of NMP at 25° C. For each vinylidene fluoride polymer composition of Examples 1 to 10 and Comparative Examples 7, 8, and 10, 15 parts by mass of the composition was added while NMP was stirred with a magnetic stirrer. The mixture was stirred at 25° C. for 30 minutes, and a 15 mass % of a binder composition was prepared.

On the other hand, each vinylidene fluoride polymer composition of Comparative Examples 1 to 6 and 9 was added to NMP so as to give a concentration of 6 mass %. The mixture was stirred in the same manner as described above, and a binder composition was prepared.

(3) Preparation of Polymer B Solution

Into a conical flask 94 parts by mass of NMP at 25° C. was weighed, and 6 parts by weight of the Polymer B was added while NMP was stirred using a magnetic stirrer. The mixture was stirred at 50° C. for 5 hours, and a solution of Polymer B was prepared.

(4) Preparation of Electrode Mixture

A dispersion containing an active material was prepared using lithium cobaltate (C5H) available from Nippon Chemical Industrial Co., Ltd. as a positive electrode active material, carbon black (SUPER P) available from Imerys Graphite & Carbon as a conductive additive, and N-methyl-2-pyrrolidone (NMP) with a purity of 99.8% as a dispersion medium. The mixing ratio of the solid components C5H:SUPER P:polyvinylidene fluoride polymer composition (PVDF):Polymer B in the electrode mixture was 100:2:1:1. The binder composition was used for the PVDF.

Specifically, 20 g of C5H and 0.4 g of SUPER P were precisely weighed into a polypropylene container and mixed by stirring at 800 rpm for 1 minute using a kneader (Awatori Rentaro) available from THINKY Corporation. The mixture was allowed to cool until the sample temperature reached 25° C. Then, 3.33 g of the Polymer B solution as a dispersion stabilizer and 1.09 g of NMP were added, and a nonvolatile content of the electrode mixture was adjusted to 83 mass %. The added mixture was mixed with a spatula and was thereafter kneaded at 2000 rpm for 3 minutes using the Awatori Rentaro (primary kneading step). The mixture was allowed to cool again until the sample temperature reached 25° C., and then the binder composition was added to the stirred liquid. The amount of the binder composition added was 1.33 g for the binder composition with a vinylidene fluoride polymer composition content of 15 mass % and 3.33 g for the binder composition with a vinylidene fluoride polymer composition content of 6 mass %. In addition, the amount of NMP was further adjusted so that a non-volatile content of the electrode mixture was adjusted to the value listed in Table 3. The added mixture was mixed with a spatula and was thereafter kneaded at 800 rpm for 2 minutes using the Awatori Rentaro, and thus, an electrode mixture was obtained (secondary kneading step). The sample temperature after kneading was 28° C. After the preparation of the mixture, the electrode mixture was stored at 25° C. The electrode mixture was measured for the viscosity at 25° C. and a shear rate of 2 s⁻¹ for 300 seconds using an E-type viscosimeter (“RE-215” available from Toki Sangyo Co., Ltd.), and the viscosity value after 300 seconds was determined to be approximately from 4 to 9 Pa·s.

(5) Production of Electrode

Each resulting electrode mixture was applied onto a 15-μm thick aluminum foil with a bar coater and dried, and an electrode was obtained. The electrode was dried at 110° C. for 30 minutes in a thermostatic vessel with nitrogen circulation. An electrode with a one-side areal weight of 200±20 g/m² was used as an electrode for evaluation.

4. Evaluation of Electrode

The resulting electrode was evaluated for peel strength of the mixture layer and surface smoothness of the electrode by the methods below. The results are shown in Table 3.

(1) Peel Strength of Mixture Layer

The peel strength of the mixture layer was determined by bonding the mixture layer-formed surface and a thick plastic plate (made of acrylic resin, thickness 5 mm) with double-sided tape and performing a 900 peel strength test in accordance with JIS K 6854-1. The test speed was 10 mm per minute.

(2) Arithmetic Average Roughness of Electrode Surface

The arithmetic average roughness Ra was measured based on JIS B 0601: 2013 using a FORMTRACER SV-C3200 (available from Mitutoyo Corporation).
Reference length: 2.5 mm
Measurement speed: 1.0 mm/s
Cutoff: λc=2.5 mm, λs=8 μm

TABLE 1-1

| | | | Surfactant | | |
|---|---|---|---|---|---|
| | Vinylidene fluoride polymer | | | Amount relative | Amount |
| | | Melting | | to vinylidene | relative |
| | | point | | fluoride polymer | to water |
| | Type | (° C.) | Type | (mass %) | (mass %) |
| Example 1 | Vinylidene fluoride | 161 | ALS | 1.8 | 0.38 |
| | polymer A | | | | |
| Example 2 | Vinylidene fluoride | 161 | ALS | 1.8 | 0.38 |
| | polymer A | | | | |
| Example 3 | Vinylidene fluoride | 161 | ALS | 2.1 | 0.50 |
| | polymer A | | | | |
| Example 4 | Vinylidene fluoride | 161 | ALS | 2.1 | 0.50 |
| | polymer A | | | | |
| Example 5 | Vinylidene fluoride | 161 | ALS | 2.1 | 0.50 |
| | polymer A | | | | |
| Example 6 | Vinylidene fluoride | 161 | ALS | 2.1 | 0.50 |
| | polymer A | | | | |
| Example 7 | Vinylidene fluoride | 161 | SLS | 2.1 | 0.50 |
| | polymer A | | | | |
| Example 8 | Vinylidene fluoride | 161 | SLS | 2.1 | 0.50 |
| | polymer A | | | | |
| Example 9 | Vinylidene fluoride | 161 | POELEA | 2.1 | 0.50 |
| | polymer A | | | | |
| Example 10 | Vinylidene fluoride | 161 | POELEA | 2.1 | 0.50 |
| | polymer A | | | | |
| Comparative | Vinylidene fluoride | 161 | — | — | — |
| Example 1 | polymer A | | | | |
| Comparative | Vinylidene fluoride | 161 | ALS | 2.1 | 0.50 |
| Example 2 | polymer A | | | | |
| Comparative | Vinylidene fluoride | 161 | ALS | 2.1 | 0.50 |
| Example 3 | polymer A | | | | |
| Comparative | Vinylidene fluoride | 161 | ALS | 1.8 | 0.41 |
| Example 4 | polymer A | | | | |
| Comparative | Vinylidene fluoride | 161 | ALS | 1.8 | 0.41 |
| Example 5 | polymer A | | | | |
| Comparative | Vinylidene fluoride | 161 | — | — | — |
| Example 6 | polymer A | | | | |
| Comparative | Vinylidene fluoride | 161 | — | — | — |
| Example 7 | polymer A | | | | |
| Comparative | Vinylidene fluoride | 161 | — | — | — |
| Example 8 | polymer A | | | | |
| Comparative | Vinylidene fluoride | 161 | ALS | 2.2 | 0.52 |
| Example 9 | polymer A | | | | |
| Comparative | Vinylidene fluoride | 161 | — | — | — |
| Example 10 | polymer A | | | | |

TABLE 1-2

| | Heat treatment | | | | | |
|---|---|---|---|---|---|---|
| | | | Treatment | Dialysis | Drying | Powder |
| | Temperature | Treatment | time | performed | performed | heat |
| | (° C.) | form | (hr) | or not | or not | treatment |
| Example 1 | 150 | Latex | 1 | Not | Performed | — |
| | | | | performed | | |
| Example 2 | 150 | Latex | 1 | Performed | Performed | — |
| Example 3 | 145 | Latex | 1 | Not | Performed | — |
| | | | | performed | | |
| Example 4 | 145 | Latex | 1 | Performed | Performed | — |
| Example 5 | 155 | Latex | 1 | Not | Performed | — |
| | | | | performed | | |
| Example 6 | 155 | Latex | 1 | Performed | Performed | — |
| Example 7 | 150 | Latex | 1 | Not | Performed | — |
| | | | | performed | | |
| Example 8 | 150 | Latex | 1 | Performed | Performed | — |
| Example 9 | 150 | Latex | 1 | Not | Performed | — |
| | | | | performed | | |
| Example 10 | 150 | Latex | 1 | Performed | Performed | — |
| Comparative | — | — | — | — | Performed | — |
| Example 1 | | | | | | |
| Comparative | 140 | Latex | 1 | Not | Performed | — |
| Example 2 | | | | performed | | |
| Comparative | 140 | Latex | 1 | Performed | Performed | — |
| Example 3 | | | | | | |
| Comparative | 161 | Latex | 1 | Not | Performed | — |
| Example 4 | | | | performed | | |
| Comparative | 161 | Latex | 1 | Performed | Performed | — |
| Example 5 | | | | | | |
| Comparative | 140 | Powder | 1 | Not | Performed | Performed |
| Example 6 | | | | performed | | |
| Comparative | 150 | Powder | 1 | Not | Performed | Performed |
| Example 7 | | | | performed | | |
| Comparative | 160 | Powder | 1 | Not | Performed | Performed |
| Example 8 | | | | performed | | |
| Comparative | — | Latex | — | Not | Performed | — |
| Example 9 | | | | performed | | |
| Comparative | 150 | Latex | 1 | Not | Performed | — |
| Example 10 | | | | performed | | |

ALS, ammonium lauryl sulfate (anionic); SLS, sodium lauryl sulfate (anionic); POELEA, poly(oxyethylene) lauryl ether acetate (anionic)

TABLE 2-1

| | Vinylidene fluoride polymer | | |
|---|---|---|---|
| | | Melting point | Surfactant |
| | Type | (° C.) | Type |
| Example 1 | Vinylidene fluoride | 161 | ALS |
| | polymer A | | |
| Example 2 | Vinylidene fluoride | 161 | ALS |
| | polymer A | | |
| Example 3 | Vinylidene fluoride | 161 | ALS |
| | polymer A | | |
| Example 4 | Vinylidene fluoride | 161 | ALS |
| | polymer A | | |
| Example 5 | Vinylidene fluoride | 161 | ALS |
| | polymer A | | |
| Example 6 | Vinylidene fluoride | 161 | ALS |
| | polymer A | | |
| Example 7 | Vinylidene fluoride | 161 | SLS |
| | polymer A | | |
| Example 8 | Vinylidene fluoride | 161 | SLS |
| | polymer A | | |
| Example 9 | Vinylidene fluoride | 161 | POELEA |
| | polymer A | | |
| Example 10 | Vinylidene fluoride | 161 | POELEA |
| | polymer A | | |
| Comparative | Vinylidene fluoride | 161 | — |
| Example 1 | polymer A | | |
| Comparative | Vinylidene fluoride | 161 | ALS |
| Example 2 | polymer A | | |
| Comparative | Vinylidene fluoride | 161 | ALS |
| Example 3 | polymer A | | |
| Comparative | Vinylidene fluoride | 161 | ALS |
| Example 4 | polymer A | | |
| Comparative | Vinylidene fluoride | 161 | ALS |
| Example 5 | polymer A | | |
| Comparative | Vinylidene fluoride | 161 | — |
| Example 6 | polymer A | | |
| Comparative | Vinylidene fluoride | 161 | — |
| Example 7 | polymer A | | |
| Comparative | Vinylidene fluoride | 161 | — |
| Example 8 | polymer A | | |
| Comparative | Vinylidene fluoride | 161 | ALS |
| Example 9 | polymer A | | |
| Comparative | Vinylidene fluoride | 161 | — |
| Example 10 | polymer A | | |

TABLE 2-2

| | Vinylidene fluoride polymer dispersion | | | |
|---|---|---|---|---|
| | 30° C. | Rate of | | Thickening |
| | viscosity | change in | | temperature |
| | (mPa/s) | content (*2) | X/Y (*3) | (° C.) |
| Example 1 | 2.9 | <0.1% | 1.0 | 43.8 |
| Example 2 | 3.6 | 0.2% | 1.2 | 45.0 |
| Example 3 | 4.1 | 1.3% | 1.4 | 38.8 |
| Example 4 | 8.4 | <0.1% | 2.8 | 39.6 |
| Example 5 | 6.3 | <0.1% | 2.1 | 47.8 |
| Example 6 | 11.2 | <0.1% | 3.7 | 50.5 |
| Example 7 | 3.3 | 0.8% | 1.1 | 43.8 |
| Example 8 | 3.3 | 1.5% | 1.1 | 42.8 |
| Example 9 | 3.8 | 0.4% | 1.3 | 43.1 |
| Example 10 | 3.4 | <0.1% | 1.1 | 44.8 |
| Comparative | 238.9 | *1 | 79.6 | N.D. |
| Example 1 | | | | |
| Comparative | 94.3 | *1 | 31.4 | N.D. |
| Example 2 | | | | |
| Comparative | 226.4 | *1 | 75.5 | N.D. |
| Example 3 | | | | |
| Comparative | 297.4 | *1 | 99.1 | N.D. |
| Example 4 | | | | |
| Comparative | 254.4 | *1 | 84.8 | N.D. |
| Example 5 | | | | |
| Comparative | 793.9 | *1 | 264.6 | N.D. |
| Example 6 | | | | |
| Comparative | 40.6 | 7.0% | 13.5 | 35.9 |
| Example 7 | | | | |
| Comparative | 10.0 | 68.5% | 3.3 | 43.9 |
| Example 8 | | | | |
| Comparative | 558.8 | *1 | 186.3 | N.D. |
| Example 9 | | | | |
| Comparative | 35.4 | 4.6% | 11.8 | 41.1 |
| Example 10 | | | | |

*1 Not measured because of high viscosity of the vinylidene fluoride polymer dispersion (vinylidene fluoride polymer content 6 mass %)
(*2) Rate of change in the content in an upper 40 volume % portion before and after the vinylidene fluoride polymer dispersion (vinylidene fluoride polymer content 6 mass %) was allowed to stand undisturbed for 15 minutes
(*3) Viscosity of the vinylidene fluoride polymer dispersion (vinylidene fluoride polymer content 6 mass %)/viscosity of NMP

TABLE 3-1

Physical properties (parameters)
Vinylidene fluoride polymer composition

| | | | | Residual |
|---|---|---|---|---|
| | Tm₁ | Tm₂ | ΔH | surfactant amount |
| | (° C.) | (° C.) | (J/g) | (mass %) |
| Example 1 | 163.5 | 163.4 | 53.4 | 2.4 |
| Example 2 | 163.6 | 163.8 | 51.8 | 1.6 |
| Example 3 | 161.2 | 163.6 | 49.7 | 2.5 |
| Example 4 | 161.1 | 163.4 | 51.8 | 1.3 |
| Example 5 | 168.3 | 163.8 | 53.0 | 2.6 |
| Example 6 | 163.9 | 163.4 | 50.0 | 1.6 |
| Example 7 | 163.2 | 163.5 | 47.1 | 2.7 |
| Example 8 | 163.2 | 163.4 | 54.2 | 1.7 |
| Example 9 | 162.7 | 162.5 | 48.6 | 3.5 |
| Example 10 | 162.6 | 162.2 | 53.2 | 2.8 |
| Comparative | 160.7 | 162.9 | 38.0 | — |
| Example 1 | | | | |
| Comparative | 160.3 | 163.4 | 46.4 | 3.4 |
| Example 2 | | | | |
| Comparative | 160.4 | 163.5 | 46.7 | 1.6 |
| Example 3 | | | | |
| Comparative | 160.4 | 163.3 | 40.4 | 2.6 |
| Example 4 | | | | |
| Comparative | 161.4 | 164.2 | 40.0 | 1.4 |
| Example 5 | | | | |
| Comparative | 160.9 | 162.7 | 45.4 | — |
| Example 6 | | | | |
| Comparative | 154.6 | 163.0 | 52.7 | — |
| Example 7 | | | | |
| Comparative | 163.9 | 162.4 | 50.6 | — |
| Example 8 | | | | |
| Comparative | 160.4 | 163.2 | 41.4 | 3.5 |
| Example 9 | | | | |
| Comparative | 160.8 | 163.4 | 50.8 | — |
| Example 10 | | | | |

TABLE 3-2

| | Physical properties (parameters) | | | | | |
|---|---|---|---|---|---|---|
| | Electrode mixture | | | | Electrode mixture layer | |
| | Vinylidene | | | | | Arithmetic |
| | fluoride | Status of | | | | average |
| | polymer | vinylidene | Nonvolatile | | | roughness |
| | composition | fluoride | component | | Peel | of electrode |
| | blending | polymer | amount | Viscosity | strength | surface |
| | ratio | composition | (mass %) | (Pa · s) | (gf/mm) | (μm) |
| Example 1 | 0.5 | Dispersed | 75 | 8.3 | 2.2 | 2.3 |
| Example 2 | 0.5 | Dispersed | 75 | 7.7 | 3.2 | 1.9 |
| Example 3 | 0.5 | Dispersed | 75 | 6.4 | 2.1 | 1.7 |
| Example 4 | 0.5 | Dispersed | 75 | 6.6 | 2.5 | 2.0 |
| Example 5 | 0.5 | Dispersed | 75 | 7.5 | 2.3 | 1.8 |
| Example 6 | 0.5 | Dispersed | 75 | 7.3 | 2.8 | 2.1 |
| Example 7 | 0.5 | Dispersed | 75 | 8.3 | 2.0 | 1.8 |
| Example 8 | 0.5 | Dispersed | 75 | 7.0 | 2.5 | 1.7 |
| Example 9 | 0.5 | Dispersed | 76 | 7.2 | 2.6 | 2.1 |
| Example 10 | 0.5 | Dispersed | 76 | 6.6 | 2.5 | 1.8 |
| Comparative | 0.5 | Dissolved | 72.5 | 7.7 | 2.6 | 2.4 |
| Example 1 | | | | | | |
| Comparative | 0.5 | Dissolved | 73.5 | 7.7 | 2.1 | 1.9 |
| Example 2 | | | | | | |
| Comparative | 0.5 | Dissolved | 73.5 | 8.5 | 2.7 | 2.4 |
| Example 3 | | | | | | |
| Comparative | 0.5 | Dissolved | 72.5 | 7.5 | 1.8 | 1.9 |
| Example 4 | | | | | | |
| Comparative | 0.5 | Dissolved | 72.5 | 6.8 | 2.3 | 1.8 |
| Example 5 | | | | | | |
| Comparative | 0.5 | Dissolved | 72.5 | 9.1 | 3.5 | 1.9 |
| Example 6 | | | | | | |
| Comparative | 0.5 | Dispersed | 73.9 | 8.7 | 3.0 | 3.3 |
| Example 7 | | | | | | |
| Comparative | 0.5 | Dispersed | 73.9 | 4.4 | 3.7 | 4.8 |
| Example 8 | | | | | | |
| Comparative | 0.5 | Dissolved | 72.5 | 7.7 | 2.3 | 1.8 |
| Example 9 | | | | | | |
| Comparative | 0.5 | Dispersed | 73.9 | 9.1 | 3.0 | 4.2 |
| Example 10 | | | | | | |

As shown in Tables 1 to 3 above, when the ratio of the viscosity X of the vinylidene fluoride polymer dispersion (vinylidene fluoride polymer content 6 mass %) at 30° C. to the viscosity Y of N-methyl-2-pyrrolidone at 30° C. was 20 or less, and the rate of change in the content in the upper 40 volume % portion before and after the vinylidene fluoride polymer dispersion (vinylidene fluoride polymer content 6 mass %) was allowed to stand undisturbed for 15 minutes was 2 mass % or less, the peel strength was high and the arithmetic average roughness of the electrode surface was low even when the nonvolatile component amount of the composition for a laminated wood layer was 75 mass % or greater (Examples 1 to 10).

On the other hand, when the vinylidene fluoride polymer composition dissolved in NMP (Comparative Examples 1 to 6 and 9), the electrode surface tended to have good smoothness, but the viscosity of the composition for a mixture increased, failing to increase the amount of nonvolatile components in the composition for a mixture to 75 mass % or greater. Furthermore, even when the vinylidene fluoride polymer composition was dispersed in NMP, the smoothness of the electrode surface easily decreased when the rate of change in the content in the upper 40 volume % before and after the vinylidene fluoride polymer dispersion (vinylidene fluoride polymer content 6 mass %) was allowed to stand undisturbed for 15 minutes was higher than 2 mass % (Comparative Examples 7, 8, and 10).

The present application claims priority based on JP 2020-198127 filed on Nov. 30, 2020. The contents described in the specification of this application are all incorporated in the specification of the present application.

### INDUSTRIAL APPLICABILITY

The vinylidene fluoride polymer composition according to an embodiment of the present invention is difficult to swell and dissolve in N-methyl-2-pyrrolidone. In addition, an electrode with a smooth surface can be formed with the vinylidene fluoride polymer composition. Thus, the vinylidene fluoride polymer composition is very useful in preparation of an electrode for a secondary battery and the like.

1. A vinylidene fluoride polymer composition comprising a vinylidene fluoride polymer having a melting point of 130° C. or higher, wherein
when the vinylidene fluoride polymer composition and N-methyl-2-pyrrolidone are mixed to prepare a vinylidene fluoride polymer dispersion having a content of the vinylidene fluoride polymer of 6 mass %,
a ratio of a viscosity of the vinylidene fluoride polymer dispersion at 30° C. measured by a parallel plate rheometer at a shear rate of 100 s⁻¹ to a viscosity of N-methyl-2-pyrrolidone at 30° C. measured by a parallel plate rheometer at a shear rate of 100 s⁻¹ is 20 or less, and
when the vinylidene fluoride polymer dispersion is stirred and then allowed to stand undisturbed for 15 minutes, a rate of change in a content of the vinylidene fluoride polymer in an upper 40 volume % portion of the vinylidene fluoride polymer dispersion before and after the dispersion is allowed to stand undisturbed is 2 mass % or less.

2. The vinylidene fluoride polymer composition according to claim 1, wherein
the vinylidene fluoride polymer includes 90 mass % or greater of a structural unit derived from vinylidene fluoride.

3. The vinylidene fluoride polymer composition according to claim 1,
further comprising a surfactant including a non-perfluoro group as a hydrophobic group and an ionic group as a hydrophilic group.

4. The vinylidene fluoride polymer composition according to claim 3, wherein an amount of the surfactant is 0.001 parts by mass or greater and 3 parts by mass or less per 100 parts by mass of a total amount of the vinylidene fluoride polymer and the surfactant.

5. The vinylidene fluoride polymer composition according to claim 1, wherein
when a shear viscosity of the vinylidene fluoride polymer dispersion is measured at a shear rate of 100 s⁻¹ by a parallel plate rheometer while the vinylidene fluoride polymer dispersion is heated from 25° C. to 80° C. at a temperature increasing rate of 5° C./min,
a temperature at which a shear viscosity reaches five times a shear viscosity at 30° C. is 35° C. or higher and 60° C. or lower.

6. A resin composition comprising:
the vinylidene fluoride polymer composition described in claim 1 and
an additional resin,
wherein the additional resin is at least one polymer selected from the group consisting of vinylidene fluoride-based polymers other than the vinylidene fluoride polymer, polyacrylonitrile, nitrile rubber, poly((meth)acrylic acid) and esters of poly((meth)acrylic acid), poly(vinylpyrrolidone), poly(vinyl alcohol), poly(vinyl acetal), poly(vinyl butyral), and cellulose ether.

7. A method of producing a vinylidene fluoride polymer composition, the method comprising:
obtaining a latex in which an untreated vinylidene fluoride polymer is dispersed in water; and
heating the latex at a temperature, the temperature being: lower than a melting point of the untreated vinylidene fluoride polymer; not lower than the melting point minus 20° C.; and not lower than 100° C., in a state where a surfactant is present in the latex, the surfactant having a non-perfluoro group as a hydrophobic group and an ionic group as a hydrophilic group.

8. The method of producing a vinylidene fluoride polymer composition according to claim 7, further comprising:
adding the surfactant after the obtaining the latex and before the heating the latex.

9. An electrode mixture comprising:
the vinylidene fluoride polymer composition described in claim 1,
an active material, and
a dispersion medium.

10. An electrode mixture comprising:
the resin composition described in claim 6, an active material, and
a dispersion medium,
wherein the polymer in the resin composition is dissolved in the dispersion medium.

11. An electrode comprising a mixture layer, the mixture layer including:
the vinylidene fluoride polymer composition described in claim 1 and
an active material.

12. A method of producing an electrode, the method comprising:
mixing the vinylidene fluoride polymer composition described in claim 1, an active material, and a dispersion medium to obtain an electrode mixture; and
applying the electrode mixture onto a current collector and drying the electrode mixture,
wherein a temperature of the electrode mixture is maintained at 60° C. or lower during a period from preparation to application of the electrode mixture.

13. An electrode comprising a mixture layer, the mixture layer including:
the resin composition described in claim 6 and
an active material.

14. A method of producing an electrode, the method comprising:
mixing the resin composition described in claim 6, an active material, and a dispersion medium to obtain an electrode mixture; and
applying the electrode mixture onto a current collector and drying the electrode mixture,
wherein a temperature of the electrode mixture is maintained at 60° C. or lower during a period from preparation to application of the electrode mixture.
